(19) United States
(12) Patent Application Publication
(10) Pub. No.: US 2024/0370574 A1
(43) Pub. Date: Nov. 7, 2024

(54) SECURITY EVALUATION INDEX CALCULATION APPARATUS, SECURITY EVALUATION INDEX CALCULATION METHOD, AND PROGRAM

(71) Applicant: NIPPON TELEGRAPH AND TELEPHONE CORPORATION, Tokyo (JP)

(72) Inventors: Takayuki MIURA, Tokyo (JP); Koji CHIDA, Tokyo (JP); Toshiki SHIBAHARA, Tokyo (JP); Atsunori ICHIKAWA, Tokyo (JP); Masanobu KII, Tokyo (JP)

(21) Appl. No.: 18/688,893

(22) PCT Filed: Oct. 8, 2021
(86) PCT No.: PCT/JP2021/037469

§ 371 Date: Mar. 4, 2024

(51) Int. Cl. G06F 21/57

(52) U.S. Cl. CPC G06F 21/577; G06F 2221/034

(57) ABSTRACT

According to one embodiment, a security evaluation index calculation apparatus includes: an input unit configured to input a synthesized data generation algorithm M including a parameter generation algorithm for generating a generation parameter from a data set including a plurality of pieces of data and a generation algorithm for generating synthesized data from the generation parameter, a data set D that is a privacy protection target, a sensitivity range R_{D} indicating a set of generation parameters of an adjacent data set that is a data set in which only one piece of data is different from the data set D, and a tolerance δ; a probability density function calculation unit configured to calculate a probability density function f describing a probability distribution followed by an output M(D) when the data set D is input to the synthesized data generation algorithm M; a region calculation unit configured to calculate, as U(t)=f⁻¹([t, ∞)), a region U_{δ}=U(t_{δ}) corresponding to t_{δ} in which a value obtained by integrating f(x) with U(t) is 1−δ; and an evaluation index calculation unit configured to calculate, as a safety evaluation index for randomness when the generation algorithm generates the synthesized data, an upper limit on U_{δ} and R_{D} of a function g defined by the probability density function f and a probability density function f′ describing a probability distribution followed by an output M(D′) when an adjacent data set D′ of the data set D is input to the synthesized data generation algorithm M.

### TECHNICAL FIELD

The present invention relates to a security evaluation index calculation apparatus, a security evaluation index calculation method, and a program.

### BACKGROUND ART

In recent years, utilization of data has become active against the background of increases in an amount and types of analyzable data, development of machine learning technologies including deep learning, and the like. In particular, utilization of data related to individuals is expected in various fields such as the medical field and the advertising field. However, since such data includes individual's private information, attention is required with legal and social responsibilities in handling of the data. Therefore, privacy protection technologies capable of enabling utilization of data while protecting individual privacy have been actively studied.

As a privacy protection technology capable of enabling utilization of a large amount of individual data while protecting privacy, a synthesized data generation technology has been proposed (Non Patent Literature 1). According to the synthesized data generation technology, any value (for example, a statistical amount, a model parameter of machine learning, or the like: hereinafter also referred to as a “generation parameter”) is extracted from the original data and data is generated using the generation parameter. In this synthesized data generation technology, theoretical safety of privacy protection is guaranteed by adding noise to the generation parameter to satisfy differential privacy.

### CITATION LIST

### Non Patent Literature

Non Patent Literature 1: Li, Haoran, Li Xiong, and Xiaogian Jiang. “Differentially private synthesization of multidimensional data using copula functions.” Advances in database technology: proceedings. International conference on extending database technology. Vol. 2014. NIH Public Access, 2014.

### SUMMARY OF INVENTION

### Technical Problem

The synthesized data generation technology is a technology in which an operation itself of generating data using a generation parameter has randomness. However, in the related art, the safety of privacy protection has not been evaluated for the randomness in data generation.

An embodiment of the present invention has been made in view of the foregoing circumstances and an object of the present invention is to evaluate safety of privacy protection for randomness in data generation in a synthesized data generation technology.

### Solution to Problem

In order to achieve the above object, according to an embodiment, a safety evaluation index calculation apparatus (security evaluation index calculation apparatus) includes: an input unit configured to input a synthesized data generation algorithm M including a parameter generation algorithm for generating a generation parameter from a data set including a plurality of pieces of data and a generation algorithm for generating synthesized data from the generation parameter, a data set D that is a privacy protection target, a sensitivity range R_{D} indicating a set of generation parameters of an adjacent data set that is a data set in which only one piece of data is different from the data set D, and a tolerance δ; a probability density function calculation unit configured to calculate a probability density function f describing a probability distribution followed by an output M(D) when the data set D is input to the synthesized data generation algorithm M; a region calculation unit configured to calculate, as U(t)=f⁻¹([t, ∞)), a region U_{δ}=U(t_{δ}) corresponding to t_{δ} in which a value obtained by integrating f(x) with U(t) is 1−δ; and an evaluation index calculation unit configured to calculate, as a safety evaluation index for randomness when the generation algorithm generates the synthesized data, an upper limit on U_{δ}, and R_{D} of a function g defined by the probability density function f and a probability density function f′ describing a probability distribution followed by an output M(D′) when an adjacent data set D′ of the data set D is input to the synthesized data generation algorithm M.

### Advantageous Effects of Invention

It is possible to evaluate safety of privacy protection for the randomness in data generation in a synthesized data generation technology.

### BRIEF DESCRIPTION OF DRAWINGS

FIG. 1 is a diagram illustrating an example of a hardware configuration of a safety evaluation index calculation apparatus according to an embodiment.

FIG. 2 is a diagram illustrating an example of a functional configuration of a safety evaluation index calculation apparatus according to the embodiment.

FIG. 3 is a flowchart illustrating an example of a calculation process of a safety evaluation index according to the embodiment.

### DESCRIPTION OF EMBODIMENTS

Hereinafter, an embodiment of the present invention will be described. In the embodiment, a safety evaluation index calculation apparatus 10 (security evaluation index calculation apparatus) capable of calculating an evaluation index for evaluating safety of privacy protection for randomness in data generation in the synthesized data generation technology will be described.

### <Preparation>

Several terms will be defined below.

### <<Adjacent Data Set>>

The data set D is tabular data including a plurality of records. For example, tabular data in which an attribute indicating information regarding an individual such as a name, age, sex, and annual income is set in a column and a record including an attribute regarding each individual is set in a row can be used as the data set D.

An entire set that can be taken by the data set is E. That is, an arbitrary data set D satisfies D∈E.

At this time, a data set that is different from the data set D in only one record is written as D′ and is referred to as an adjacent data set of D. The set of the entire adjacent data set of D is written as N(D). Since the adjacent data set D′ of D is also a data set, N(D)⊂E is satisfied.

### <<Differential Privacy Under Data Fixing>>

The fact that the privacy protection randomization function M: E→Y satisfies, for a data set D∈E, (ε, δ)—differential privacy under data fixing means that for any adjacent data set D′∈N(D) and any S⊂Y, the following expression is established.

$$Pr [ M ( D ) ϵ S ] \leq {e}^{ε} Pr [ M ( {D}^{′} ) ϵ S ] + δ$$

The privacy protection randomization function is a function in which an output y∈Y for the data set D∈E has randomness.

As is apparent from the above definition, differential privacy under data fixing refers to a case where, when one data set D is fixed, the privacy protection randomization function M satisfies (ε, δ)—differential privacy for the data set D.

### <Input and Output of Safety Evaluation Index Calculation Apparatus 10>

Hereinafter, the data set D is set as a data set that is a privacy protection target, and each record included in the data set D is set as data to be synthesized by a synthesized data generation technology.

It is assumed that an entire set that can be taken by data to be synthesized is X, and this is expressed as a d-dimensional vector x∈R^{d} by application encoding. Accordingly, each record included in the data set D is also expressed as a d-dimensional vector. Hereinafter, it is assumed that the data set D of the privacy protection target includes N records. R indicates the set of all real numbers.

At this time, the safety evaluation index calculation apparatus 10 uses the following data as an input and an output.

### <<Input Data>>

Synthesized data generation algorithm M: E→R^{d}

Here, the synthesized data generation algorithm M is a privacy protection randomization function.

$$M = G ∘ P \qquad [ Math . 1 ]$$

The algorithm is represented as a composite function of two functions G and P. P: E→V is an algorithm representing a generation part of the generation parameter and G: V→R^{d} is an algorithm representing a data generation part. The generation parameter is any value (for example, a statistical value, a model parameter of machine learning, or the like) extracted from the data set of the privacy protection target.

V is a space to which the generation parameter belongs. When the generation parameter is a model parameter θ of machine learning (for example, in the case of a parameter θ_{f} of a probability density function f to be described below), θ∈V=R^{W} (where W is the number of dimensions of the model parameter θ). On the other hand, when the generation parameter is a statistical value such as the average μ∈R^{d} and the variance-covariance matrix Σ∈R^{d×d} of the database D, (μ, Σ)∈V=R^{d}×R^{d×d}.
Data set D∈R^{N×d} of privacy protection target
Sensitivity range R_{D} of generation parameter: ={P(D′)∈V|D′∈N(D)}

As is apparent from the definition, the sensitivity range R_{D} of the generation parameter is a set of generation parameters P(D′) generated from the adjacent data set D′ of the data set D.
Tolerance δ (where 0<δ<1)

### <<Output Data>>

Safety evaluation index ε

Here, the safety evaluation index ε (safety evaluation index calculation) is a real number such that ε>0, and the synthesized data generation algorithm M satisfies (ε, δ)—differential privacy under data fixing for the data set D.

As ε is closer to 0, it is more difficult to distinguish whether an output of the synthesized data generation algorithm M is obtained from the data set D or the adjacent data set D′. Conversely as ε is larger, it is easier to distinguish whether the output is obtained from the data set D or the adjacent data set D′. Therefore, ε is an index of the indistinguishable index of the data set D that is a privacy protection target, and the safety of privacy protection for randomness in data generation can be evaluated with the value of ε. In other words, ε is an index with which the safety of privacy protection of randomness that the synthesized data generation algorithm M originally has in the data generation can be evaluated.

### <Outline of Process of Safety Evaluation Index Calculation Apparatus 10>

An outline of a process of receiving the input data as an input and outputting the safety evaluation index E as output data will be described.

When f: R^{d}→R is a probability density function describing a probability distribution followed by M(D) and f′: R^{d}→R is a probability density function describing a probability distribution followed by M(D′) for an adjacent data set D′ of the data set D, a function g: R^{d}×V→R is defined as follows.

$$g ( x , P ( {D}^{′} ) ) := \vert log \frac{f ( x )}{{f}^{′} ( x )} \vert \qquad [ Math . 2 ]$$

At this time, the safety evaluation index calculation apparatus 10 according to the embodiment obtains the region U_{δ} ⊂R^{d} satisfying the following expression.

$${\int }_{{U}_{δ}} f ( x ) d x = 1 - δ \qquad [ Math . 3 ]$$

Then, the safety evaluation index calculation apparatus 10 calculates c satisfying the following expression as a safety evaluation index.

$$ε = {sup}_{x ϵ {U}_{δ} , αϵ {R}_{d}} g ( x , P ( D ) + α ) \qquad [ Math . 4 ]$$

### <Hardware Configuration of Safety Evaluation Index Calculation Apparatus 10>

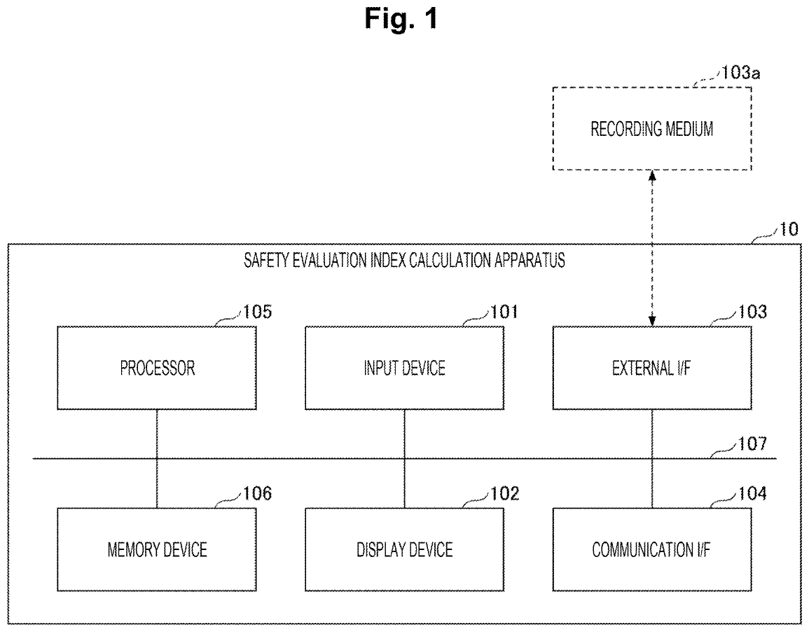

A hardware configuration of the safety evaluation index calculation apparatus 10 according to the embodiment will be described with reference to FIG. 1. FIG. 1 is a diagram illustrating an example of a hardware configuration of the safety evaluation index calculation apparatus 10 according to the embodiment.

As illustrated in FIG. 1, the safety evaluation index calculation apparatus 10 according to the embodiment is implemented with a hardware configuration of a general computer or computer system, and includes an input device 101, a display device 102, an external I/F 103, a communication I/F 104, a processor 105, and a memory device 106. The hardware is communicably connected with each other via a bus 107.

The input device 101 is, for example, a keyboard, a mouse, a touch panel, a physical button, or the like. The display device 102 is, for example, a display, a display panel, or the like. The safety evaluation index calculation apparatus 10 need not include, for example, at least one of the input device 101 or the display device 102.

The external I/F 103 is an interface with an external device such as a recording medium 103a. The safety evaluation index calculation apparatus 10 can read from and write to the recording medium 103a via the external I/F 103. Examples of the recording medium 103a include, for example, a compact disc (CD), a digital versatile disk (DVD), a secure digital memory card (SD memory card), and a Universal Serial Bus (USB) memory card.

The communication I/F 104 is an interface for connecting the safety evaluation index calculation apparatus 10 to a communication network. The processor 105 is, for example, any of various arithmetic devices such as a central processing unit (CPU) and a graphics processing unit (GPU). The memory device 106 is, for example, any of various storage devices such as a hard disk drive (HDD), a solid state drive (SSD), a random access memory (RAM), a read only memory (ROM), and a flash memory.

The safety evaluation index calculation apparatus 10 according to the embodiment has the hardware configuration illustrated in FIG. 1 and thus can implement a calculation process for a safety evaluation index to be described below. The hardware configuration illustrated in FIG. 1 is exemplary, and the safety evaluation index calculation apparatus 10 may have another hardware configuration. For example, the safety evaluation index calculation apparatus 10 may include a plurality of processors 105, a plurality of memory devices 106, or other hardware (not illustrated).

### <Functional Configuration of Safety Evaluation Index Calculation Apparatus 10>

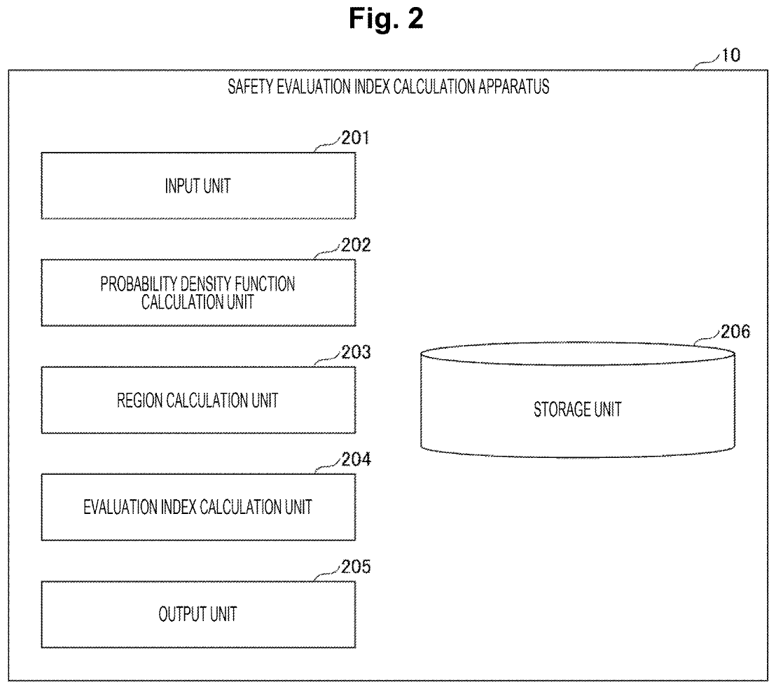

A functional configuration of the safety evaluation index calculation apparatus 10 according to the embodiment will be described with reference to FIG. 2. FIG. 2 is a diagram illustrating an example of a functional configuration of the safety evaluation index calculation apparatus 10 according to the embodiment.

As illustrated in FIG. 2, the safety evaluation index calculation apparatus 10 according to the embodiment includes an input unit 201, a probability density function calculation unit 202, a region calculation unit 203, an evaluation index calculation unit 204, and an output unit 205. These units are implemented, for example, through a process executed by the processor 105 in accordance with one or more programs installed in the safety evaluation index calculation apparatus 10. The safety evaluation index calculation apparatus 10 according to the embodiment includes a storage unit 206. The storage unit 206 is implemented by, for example, the memory device 106. However, the storage unit 206 may be implemented by, for example, a storage device (for example, a database server or the like) connected to the safety evaluation index calculation apparatus 10 via a communication network.

The input unit 201 inputs the synthesized data generation algorithm M, the data set D of a privacy protection target, the sensitivity range R_{D} of the generation parameter, and the tolerance γ from the storage unit 206.

The probability density function calculation unit 202 calculates a probability density function f describing the probability distribution followed by M(D).

The region calculation unit 203 calculates the region U_{δ}⊂R^{d} using the probability density function f and the tolerance δ.

The evaluation index calculation unit 204 calculates the safety evaluation index ε using the probability density function f, the region U_{δ}⊂R^{d}, and the sensitivity range R_{D} of the generation parameter.

The output unit 205 outputs the safety evaluation index s to a predetermined output destination determined in advance. Examples of the output destination of the safety evaluation index s include the storage unit 206, the display device 102, and other devices and apparatuses connected via a communication network.

The storage unit 206 stores the synthesized data generation algorithm M, the data set D of the privacy protection target, the sensitivity range R_{D} of the generation parameter, and the tolerance δ given to the safety evaluation index calculation apparatus 10. In addition to these, the storage unit 206 may store, for example, a midway calculation result that is obtained prior to the obtaining of the safety evaluation index ε.

### <Calculation Process of Safety Evaluation Index>

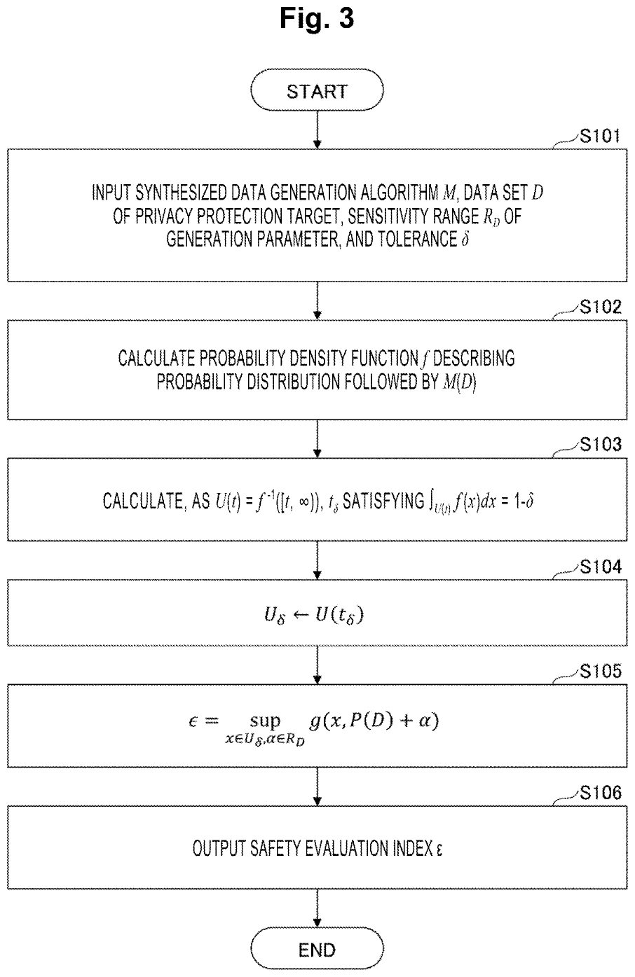

The calculation process of the safety evaluation index (security evaluation index) according to the embodiment will be described with reference to FIG. 3. FIG. 3 is a flowchart illustrating an example of a calculation process of the safety evaluation index (security evaluation index) according to the embodiment.

First, the input unit 201 inputs the synthesized data generation algorithm M, the data set D of the privacy protection target, the sensitivity range R_{D} of the generation parameter, and the tolerance δ from the storage unit 206 (step S101).

Subsequently, the probability density function calculation unit 202 calculates the probability density function f describing the probability distribution followed by M(D) (step S102).

Subsequently, the region calculation unit 203 calculates, as U(t)=f⁻¹([t, ∞), t_{δ} satisfying the following expression (step S103).

$${\int }_{U ( t )} f ( x ) d x = 1 - δ \qquad [ Math . 5 ]$$

Subsequently, the region calculation unit 203 sets U_{δ}←U (t_{δ}) (step S104).

Subsequently, the evaluation index calculation unit 204 calculates an upper limit of g(x, P(D)+α) for x∈U_{δ} and α∈R_{D} and sets the upper limit as the safety evaluation index ε (step S105). That is, the evaluation index calculation unit 204 calculates the following expression as a safety evaluation index.

$$ϵ = {sup}_{x ∈ {U}_{δ} , α ∈ {R}_{D}} g ( x , P ( D ) + α ) \qquad [ Math . 6 ]$$

Since this is a maximum value search problem, it can be solved by a known optimization method.

Then, the output unit 205 outputs the safety evaluation index ε to a predetermined output destination determined in advance (step S106).

### EXAMPLE

Hereinafter, an example in a case where the output of the synthesized data generation algorithm M follows a normal distribution (that is, when M(D) and M (D′) follow a normal distribution) will be described.

### Example 1: Case Where Output of Synthesized Data Generation Algorithm M Follows Multivariate Normal Distribution

In this example, a case where the synthesized data generation algorithm M generates the data M(D) using the average μ∈R^{d} of the database D and the variance-covariance matrix Σ∈R^{d×d} will be described.

For the adjacent data set D′∈N(D), an average is μ′∈R^{d}, and the variance-covariance matrix is Σ′∈R^{d×d}. f=f_{μ,Σ}, f′=f_{μ′,Σ′}, and the following function g: R_{d}×R_{d}×R^{d×d}→R is considered.

$$\begin{matrix}g ( x , {μ}^{′} , {Σ}^{′} ) := \vert log \frac{{f}_{μ , Σ} ( x )}{{f}_{{μ}^{′} , {Σ}^{′}} ( x )} \vert \\ = \frac{1}{2} \vert log \frac{det {Σ}^{′}}{det Σ} + {( x - μ )}^{T} {Σ}^{- 1} ( x - μ ) - {( x - {μ}^{′} )}^{T} {{Σ}^{′}}^{- 1} ( x - {μ}^{′} ) \vert \\ \leq \frac{1}{2} \vert log \frac{det {Σ}^{′}}{det Σ} \vert + \frac{1}{2} \vert {( x - μ )}^{T} {Σ}^{- 1} ( x - μ ) - {( x - {μ}^{′} )}^{T} {{Σ}^{′}}^{- 1} ( x - {μ}^{′} ) \vert\end{matrix} \qquad [ Math . 7 ]$$

T indicates transposition.

At this time, if we fix 0<δ<1, then a certain t>0 exists uniquely.

$${\int }_{{U}_{δ}} {f}_{μ , Σ} ( x ) d x = 1 - δ \qquad [ Math . 8 ]$$

The above expression is established. Here, the following expression is satisfied.

$${U}_{δ} = {f}_{μ , {Σ}^{- 1}} ( [ t , ∞ ) )$$

Accordingly, the following expression is calculated as a safety evaluation index.

$$ϵ = {sup}_{x ∈ {U}_{δ} , α ∈ {R}_{μ} , βϵ {R}_{Σ}} g ( x , P ( D ) + α ) \qquad [ Math . 9 ]$$

### Example 2: Case Where Output of Synthesized Data Generation Algorithm M Follows One-Variable Normal Distribution

In this example, a case where d=1, and the synthesized data generation algorithm M generates the data M(D) using the average μ∈R and the variance σ² ∈R of the database D will be described.

For the adjacent data set D′∈N(D), an average is μ′∈R, and a variance is σ′²∈R. The following expression is written.

$$f = {f}_{μ , {σ}^{2 ,}} {f}^{′} = {f}_{{μ}^{′} , {σ}^{′ 2}} \qquad [ Math . 10 ]$$

The following function g: R×R×R→R is considered.

$$\begin{matrix}g ( x , {μ}^{′} , {σ}^{′2} ) := \vert log \frac{{f}_{μ , {σ}^{2}} ( x )}{{f}_{{μ}^{′} , {σ}^{′2}} ( x )} \vert \\ \leq \frac{1}{2} \vert log \frac{{σ}^{′2}}{{σ}^{2}} \vert + \frac{1}{2} \vert \frac{{( x - μ )}^{2}}{{σ}^{2}} - \frac{{( x - {μ}^{′} )}^{2}}{{σ}^{′ 2}} \vert\end{matrix} \qquad [ Math . 11 ]$$

The data set D is represented as the following expression from a certain l and r.

$$D = {\{ {x}_{i} \}}_{i = 1}^{N} ∈ {[ l , r ]}^{N} \qquad [ Math . 12 ]$$

The sensitivity range R_{D} is given as the following expression.

$${R}_{D} = \{ ( μ + α , {σ}^{2} + β ) ∈ {ℝ}^{2} \vert - {Δ}_{μ} \leq α \leq {Δ}_{μ} , {Δ}_{{σ}^{2}}^{-} \leq β \leq {Δ}_{{σ}^{2}}^{+} \} \qquad [ Math . 13 ]$$

Here, the following expressions are given.

$$μ = \frac{1}{N} {{\sum }_{i = 1}}^{N} {x}_{i} , {σ}^{2} = \frac{1}{N} {{\sum }_{i = 1}}^{N} {( {x}_{i} - μ )}^{2} , {C}_{1} = r - l , {C}_{2} = max ( r - μ , μ - l ) \qquad [ Math . 14 ]$$

$${Δ}_{μ} := \frac{{C}_{1}}{N} , {Δ}_{{σ}^{2}}^{+} := \frac{{C}_{1}}{N} ( 2 {C}_{2} + \frac{N - 1}{N} {C}_{1} ) , {Δ}_{{σ}^{2}}^{-} := - \frac{{C}_{2}^{2}}{N - 1}$$

At this time, when 0<δ<1 is fixed to one, for the following probability density function describing a normal distribution of the average μ and a variance σ², only one t ∈R satisfying the following description, and therefore, x_{±δ}=μ±t is given.

$${f}_{μ , {σ}^{2}} \qquad [ Math . 15 ]$$

$${\int }_{μ - t}^{μ + t} {f}_{μ , {σ}^{2}} ( x ) d x = 1 - δ \qquad [ Math . 16 ]$$

The following expression is given.

$$\begin{matrix}L = max ( \vert log \frac{{σ}^{2} + {Δ}_{{σ}^{2}}^{+}}{{σ}^{2}} \vert , \vert log \frac{{σ}^{2} + {Δ}_{{σ}^{2}}^{-}}{{σ}^{2}} \vert ) \\ m = {max}_{\begin{matrix}x = {x}_{\pm δ} \\ α = \pm {Δ}_{μ} \\ β = {Δ}_{{σ}^{2}}^{\pm }\end{matrix}} \vert \frac{{( x - μ )}^{2}}{{σ}^{2}} - \frac{{( x - μ - α )}^{2}}{{σ}^{2} + β} \vert\end{matrix} \qquad [ Math . 17 ]$$

Here, m is a maximum value among the following eight (x, α, β).

$$( x , α , β ) = ( {x}_{δ} , {Δ}_{μ} , {Δ}_{{σ}^{2}}^{+} ) , ( x {\_}_{δ} , {Δ}_{μ} , {Δ}_{{σ}^{2}}^{+} ) , ( {x}_{δ} , {Δ}_{μ} , {Δ}_{{σ}^{2}}^{-} ) , ( x {\_}_{δ} , {Δ}_{μ} , {Δ}_{{σ}^{2}}^{-} ) , ( {x}_{δ} - {Δ}_{μ} , {Δ}_{{σ}^{2}}^{+} ) , ( {x\_}_{δ} , - {Δ}_{μ} , {Δ}_{{σ}^{2}}^{+} ) , ( {x}_{δ} , - {Δ}_{μ} , {Δ}_{{σ}^{2}}^{-} ) , ( {x\_}_{δ} , - {Δ}_{μ} , {Δ}_{{σ}^{2}}^{-} ) \qquad [ Math . 18 ]$$

At this time, the safety evaluation index E is can be calculated as the following expression.

$$ϵ = \frac{1}{2} ( L + max ( m , \frac{{Δ}_{μ} ( {x}_{δ} - μ )}{{σ}^{2}} ) ) \qquad [ Math . 19 ]$$

### Conclusion

As described above, the safety evaluation index calculation apparatus 10 according to the embodiment calculates the safety evaluation index ε as an index with which can evaluate the safety of privacy protection for the randomness that the synthesized data generation algorithm M originally has in data generation. In the related art, since the safety of privacy protection for the synthesized data generation algorithm M has not been evaluated by the safety evaluation index ε, the safety of privacy protection can be evaluated with higher accuracy.

Therefore, for example, it is possible to reduce an amount of noise added to the generation parameter by the scheme of the related art while ensuring the same safety, and it is possible to generate more useful data while protecting privacy. As one application example, for example, the safety evaluation index calculation apparatus 10 may generate the generation parameter in which the amount of noise is reduced further than in the related art while guaranteeing a certain predetermined safety by the safety evaluation index c calculated according to the embodiment, and may generate the synthesized data M(D) from the generation parameter.

The present invention is not limited to the foregoing specifically disclosed embodiment, and various modifications and changes, combinations with known technologies, and the like can be made without departing from the scope of the claims.

### REFERENCE SIGNS LIST

10 Safety evaluation index calculation apparatus
101 Input device
102 Display device
103 External I/F
103a Recording medium
104 Communication I/F
105 Processor
106 Memory device
107 Bus
201 Input unit
202 Probability density function calculation unit
203 Region calculation unit
204 Evaluation index calculation unit
205 Output unit
206 Storage unit

1. A security evaluation index calculation apparatus comprising:
a processor; and
a memory that includes instructions, which when executed, cause the processor to execute a method, said method including:
inputting:
a synthesized data generation algorithm M including both a parameter generation algorithm for generating a generation parameter from a data set including a plurality of pieces of data and a generation algorithm for generating synthesized data from the generation parameter,
a data set D that is a privacy protection target,
a sensitivity range R_{D} indicating a set of generation parameters of an adjacent data set that is a data set in which only one piece of data is different from the data set D, and
a tolerance δ;
calculating a probability density function f describing a probability distribution followed by an output M(D) when the data set D is input to the synthesized data generation algorithm M;
calculating, as U(t)=f⁻¹([t, ∞)), a region U_{δ}=U(t_{δ}) corresponding to t_{δ} in which a value obtained by integrating f(x) with U(t) is 1−δ; and
calculating, as a security evaluation index for randomness when the generation algorithm generates the synthesized data, an upper limit on U_{δ} and R_{D} of a function g defined by the probability density function f and a probability density function f′ describing a probability distribution followed by an output M(D′) when an adjacent data set D′ of the data set D is input to the synthesized data generation algorithm M.

2. The security evaluation index calculation apparatus according to claim 1, wherein, when the parameter generation algorithm is P, the sensitivity range R_{D} is expressed as R_{D}={P(D′)|D′ is an adjacent data set of the data set D}, and
the function g is defined as g(x, P(D′)):=|log(f(x)/f′(x))|.

3. The security evaluation index calculation apparatus according to claim 2, wherein the calculating of the security evaluation index includes calculating an upper limit of g(x, P(D)+α) as the security evaluation index for x∈U_{δ} and α∈R_{D}.

4. The security evaluation index calculation apparatus according to claim 1, wherein an output when an arbitrary data set is input to the synthesized data generation algorithm M follows a normal distribution.

5. The security evaluation index calculation apparatus according to claim 1, wherein the generation parameter is a model parameter of machine learning, or an average and a variance or variance covariance matrix of data including the data set D.

6. A security evaluation index calculation method of causing a computer to perform:
inputting:
a synthesized data generation algorithm M including both a parameter generation algorithm for generating a generation parameter from a data set including a plurality of pieces of data and a generation algorithm for generating synthesized data from the generation parameter,
a data set D that is a privacy protection target,
a sensitivity range R_{D} indicating a set of generation parameters of an adjacent data set that is a data set in which only one piece of data is different from the data set D, and
a tolerance δ;
calculating a probability density function f describing a probability distribution followed by an output M(D) when the data set D is input to the synthesized data generation algorithm M;
calculating, as U(t)=f⁻¹([t, ∞)), a region U_{δ}=U(t_{δ}) corresponding to t_{δ} in which a value obtained by integrating f(x) with U(t) is 1−δ; and
calculating, as a security evaluation index for randomness when the generation algorithm generates the synthesized data, an upper limit on U_{δ} and R_{D} of a function g defined by the probability density function f and a probability density function f′ describing a probability distribution followed by an output M(D′) when an adjacent data set D′ of the data set D is input to the synthesized data generation algorithm M.

7. A non-transitory computer-readable recording medium having computer-readable instructions stored thereon, which when executed, cause a computer including a memory and a processor to execute the method executed by the processor in the security evaluation index calculation apparatus according to claim 1.
